(19) United States
(12) Patent Application Publication
(10) Pub. No.: US 2014/0202842 A1
(43) Pub. Date: Jul. 24, 2014

(54) PUSH BUTTON SWITCH

(71) Applicant: OMRON CORPORATION, Kyoto-shi (JP)

(72) Inventor: Takayuki ABE, Kurayoshi-shi (JP)

(73) Assignee: OMRON CORPORATION, Kyoto-shi (JP)

(21) Appl. No.: 14/142,904

(22) Filed: Dec. 29, 2013

(30) Foreign Application Priority Data
Jan. 18, 2013 (JP) 2013-007002

(51) Int. Cl. H01H 13/14

(52) U.S. Cl. CPC H01H 13/14
USPC 200/529

(57) ABSTRACT

A push button switch including a base having a contact disposition surface on which a plurality of fixed contacts are positioned around a circle, a rotor rotatably disposed on the base about a rotating shaft passing through a center of the circle, the rotor including a plurality of movable contacts positioned to come into contact with and separate from the plurality of fixed contacts about the rotating shaft, a push button adjoined to an outer peripheral surface of the rotor and movably disposed in a direction orthogonal to the rotating shaft of the rotor, the push button being configured to rotate the rotor by a push operation;

and a cover configured to accommodate the base, the rotor, and the push button, the cover exposing an operation unit of the push button.

### CROSS REFERENCE TO RELATED APPLICATION

This application is related to and claims the benefit of Japanese Patent Application Number 2013-007002, filed 18 Jan. 2013, the contents of said application being herein incorporated by reference in their entirety.

### BACKGROUND OF THE INVENTION

1. Technical Field

The present invention relates to a push button switch whose contacts are switched by a pressing-down operation.

2. Related Art

Along with a recent tendency to thinner thickness of electronic devices, push button switches with a low height, that is, so-called “low profile” types, have been required in push button switches used for electronic devices, as well. On the other hand, if a switch becomes low profile, then the stroke of a push button becomes generally smaller, and operability of the switch is decreased. Accordingly, a switch with a low profile and a large stroke is preferable.

In Japanese Unexamined Patent Publication No. 2003-68164, there is described a push button switch having fixed contacts disposed on contact point accommodating space including a body and cap, and a movable contact spring integrally disposed with a push button, so that a movable contact point disposed on the movable contact spring slides the fixed contact point when the push button is depressed.

In the push button switch described in Japanese Unexamined Patent Publication No. 2003-68164, since the movable contact spring is integrally formed with the push button, if the stroke of the push button becomes larger, the distance of movement of the movable contact spring also becomes larger, which requires larger housing for accommodating the movable contact spring. Conversely, if the housing becomes smaller, that is, becomes low profile, the stroke of the push button inevitably becomes smaller, as well. Accordingly, there have been limitations in decreasing the height of a push button while maintaining the large stroke of the push button. Since the movable contact spring moves in a direction of movement of the push button, it has been required that the height of the housing is determined in consideration not only of the dimension for accommodating a contact mechanism such as a movable contact spring, but also of the distance of movement of the movable contact spring. Further, in the push button switch described in Japanese Unexamined Patent Publication No. 2003-68164, since the terminals are projected downward from the base, the height inclusive of the terminals is high, and the push button switch thus cannot be regarded as low profile.

### SUMMARY

The present invention has been devised to solve the problems described above, and provides a push button switch with a low profile and a large stroke.

A push button switch including a base having a contact disposition surface on which a plurality of fixed contacts are positioned around a circle, a rotor rotatably disposed on the base about a rotating shaft passing through a center of the circle, the rotor including a plurality of movable contacts positioned to come into contact with and separate from the plurality of fixed contacts about the rotating shaft, a push button adjoined to an outer peripheral surface of the rotor and movably disposed in a direction orthogonal to the rotating shaft of the rotor, the push button being configured to rotate the rotor by a push operation; and a cover configured to accommodate the base, the rotor, and the push button, the cover exposing an operation unit of the push button.

### BRIEF DESCRIPTION OF THE DRAWINGS

FIGS. 1A and 1B, each illustrates an external view of a push button switch according to the present invention, in which FIG. 1A is a perspective view as seen from obliquely above, and FIG. 1B is a perspective view as seen from obliquely below;

FIG. 2 is an exploded perspective view of the push button switch in FIGS. 1A and 1B;

FIG. 3A is a front view of a base; and FIG. 3B is a perspective view of the base;

FIG. 4A is an exploded perspective view of a rotor as seen from one side; and FIG. 4B is an exploded perspective view as seen from the side of the rotor opposite that of FIG. 4A;

FIG. 5 is a perspective view of a holder;

FIG. 6 is a perspective view of a case in which a front surface is partially cutout;

FIG. 7 is a sectional view of the push button switch in FIGS. 1A and 1B taken along the line VII-VII;

FIG. 8 is a sectional view of the push button switch in FIGS. 1A and 1B taken along the line VIII-VIII; and

FIGS. 9A, 9B, and 9C are sectional views illustrating operation of the push button switch in FIGS. 1A and 1B.

### DETAILED DESCRIPTION

Next, an embodiment of the present invention will be described with reference to the accompanying drawings.

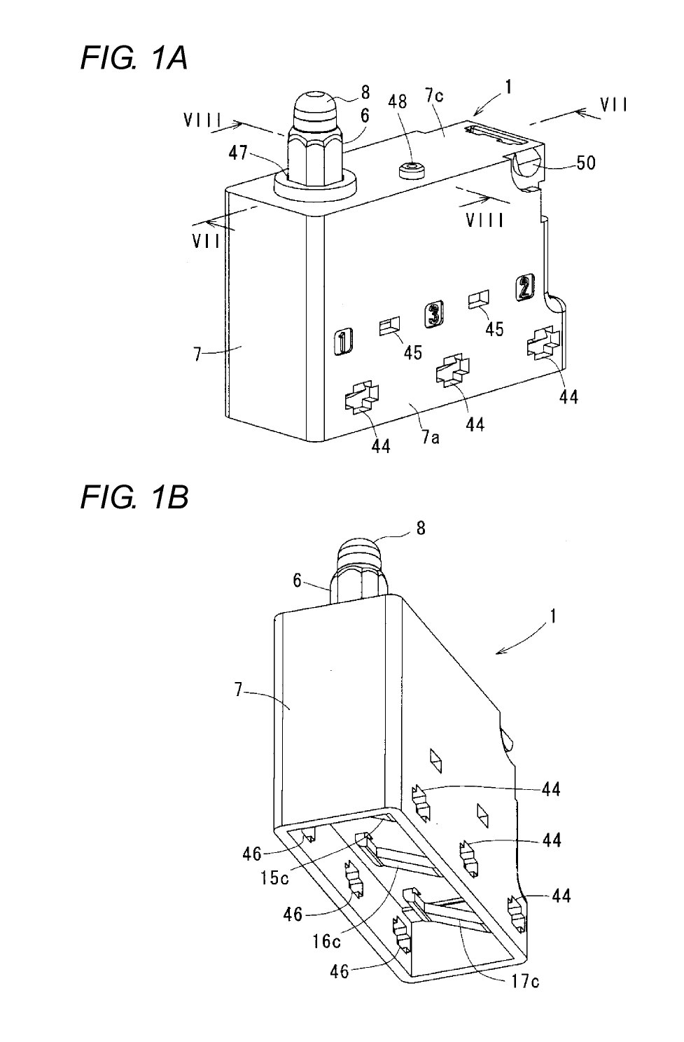

FIGS. 1A and 1B illustrate a push button switch 1 according to the present invention. In the following description, a surface on which a push button 6 is seen to be located at upper left thereof (the surface marked, 1, 2, and 3 in FIG. 1A) is set to be a front surface. With respect to the front surface, surfaces located at upper, lower, left, right, and reverse sides are referred to as a top surface, a bottom surface, left side surface, right side surface, and a back surface, respectively.

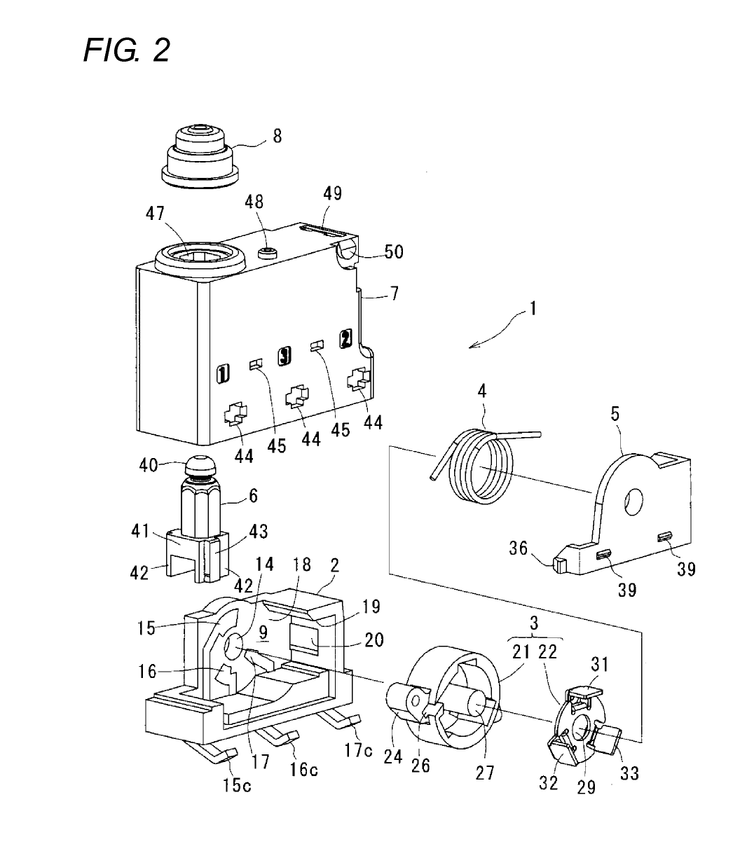

As illustrated in FIG. 2, the push button switch 1 includes a base 2, a rotor 3, a biasing spring 4, a holder 5, the push button 6, a cover 7, and a cap 8.

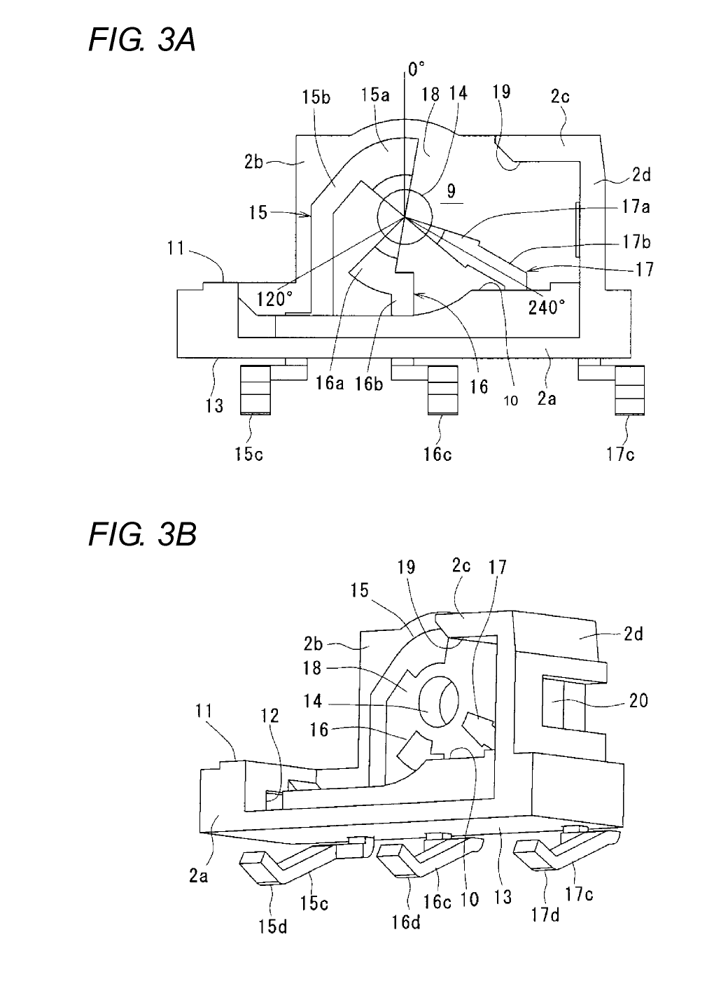

As illustrated in FIGS. 3A and 3B, the base 2 has a bottom portion 2a, a back portion 2b, an upper portion 2c, and a right side portion 2d, and in the space surrounded by these, a rotor accommodating space 9 is formed. In the rotor accommodating space 9, the front surface, the left side surface, and a part of the top surface are open.

At the right side of the top surface of the bottom portion 2a of the base 2, there is formed a rotor contact step 10 with which a stopper 25 of the rotor 3 to be described below is brought into contact. At the left side of the top surface of the bottom portion 2a of the base 2, there are formed a button contact step 11 with which a lower end of the push button 6 to be described below is brought into contact, and a locking portion 12 to which an engaging projection 36 of the holder 5 to be described below is to be locked. The bottom surface of the bottom portion 2a forms a terminal disposition surface 13.

At the center of the back portion 2b of the base 2, there is formed a shaft hole 14 of the rotor 3 to be described below. In the back portion 2b, three fixed contact members made of electrically-conductive metallic materials, i.e. a first, a second, and a third fixed contact members 15, 16, and 17 respectively are disposed by means of insert molding. The first fixed contact member 15 includes a common fixed contact 15a located in proximity to the shaft hole 14, a base portion 15b extending from the common fixed contact 15a to the bottom surface of the bottom portion 2a, and a terminal portion 15c projecting from the lower end of the base portion 15b to outward of the bottom portion 2a. Similarly, the second fixed contact member 16 includes a constantly-opened fixed contact 16a, a base portion 16b, and a terminal portion 16c. Likewise, the third fixed contact member 17 includes a constantly-closed fixed contact 17a, a base portion 17b, and a terminal portion 17c.

The common fixed contact 15a, the constantly-opened fixed contact 16a, and the constantly-closed fixed contact 17a of the first, second, and third fixed contact members 15, 16, and 17, respectively, are positioned in a circle about the shaft hole 14, such that they are exposed to a contact disposition surface 18 on the front surface of the back portion 2b. In the present embodiment, in the case where positions at 0°, 120° and 240° counterclockwise when viewing the front surface of the back portion 2b are set as reference positions, the common fixed contact 15a is formed at the position ranging from −10° to 50°, the constantly-opened fixed contact 16a is formed at the position ranging from 135° to 170°, and the constantly-closed fixed contact 17a is formed at the position ranging from 230° to 250°. Accordingly, a common movable contact 31c of the rotor 3 to be described below is in contact with the common fixed contact 15a of the first fixed contact member 15 at the initial position at 0°, a constantly-opened movable contact 32c is opened and separated from the constantly-opened fixed contact 16a at the initial position at 120°, and a constantly-closed movable contact 33c is closed to the constantly-closed fixed contact 17a at the position at 240°. It should be noted that the contact dispositions are not limited to the above.

The terminal portions 15c, 16c, and 17c of the first, second, and third fixed contact members 15, 16, and 17, respectively, are substantially the same shape. Therefore, the terminal portion 15c will be described by way of example. The terminal portion 15c is bent 90° in a left-right direction from the lower end of the base portion 15b to extend in parallel to the bottom portion 2a, then again bent 90° toward the front to extend at an angle in a direction away from the terminal disposition surface 13, further bent upward to form a bent portion 15d, and extends toward the front in a direction close to the terminal disposition surface 13.

The inner surface at the left edge of the upper portion 2c of the base 2 serves as a locking portion 19 which is locked to which one end of the biasing spring 4 to be described below is to be locked. On the right side portion 2d of the base 2, there is formed a rectangular shaped locking hole 20 to which an engaging projection 37 of the holder 5 to be described below is to be locked.

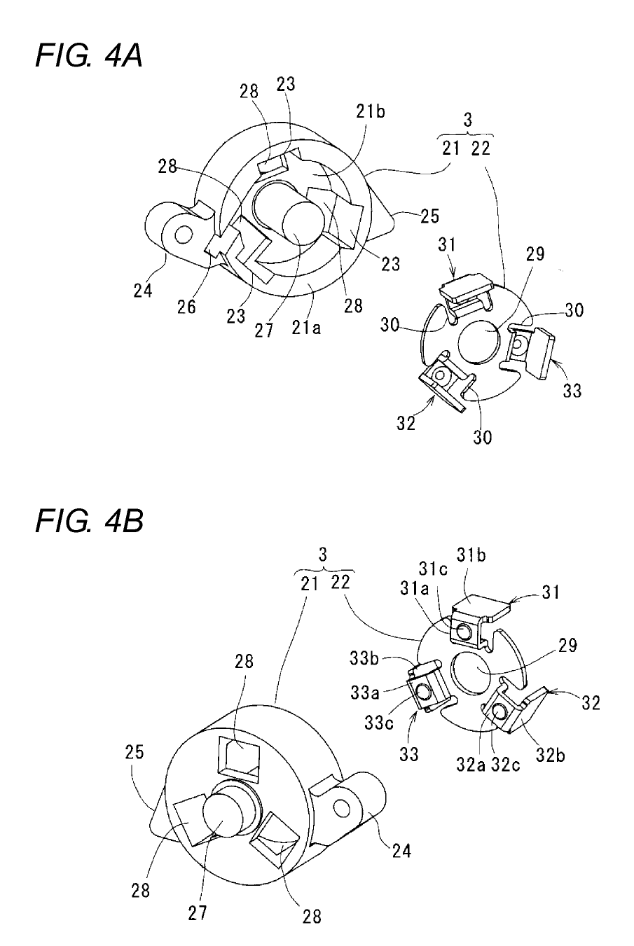

The rotor 3 includes a rotor main body 21, and a movable contact member 22, as illustrated in FIGS. 4A and 4B.

The rotor main body 21 includes a cylindrical portion 21 a and an end wall 21b that closes one end of the cylindrical portion 21a. On the inner peripheral surface of the cylindrical portion 21a, three engaging grooves 23 are formed at circumferentially equally-spaced apart positions. At the side 180° away from the outer peripheral surface of the cylindrical portion 21a, an engaging projecting portion 24 and the stopper 25 are projectingly provided. On an end surface opposite to the end wall 21b of the cylindrical portion 21a, in proximity to the engaging projecting portion 24, there is formed a locking groove 26 to which another end of the biasing spring 4 to be described below is locked. On the end wall 21b, there is formed a rotating shaft 27 that extends from the inner surface and the outer surface of the end wall 21b toward the central axis of the cylindrical portion 21a. Three rectangular-shaped holes 28 are formed at circumferentially equally-spaced apart positions about the rotating shaft 27 of the end wall 21b, each of the rectangular-shaped holes 28 communicating with the respective engaging grooves 23 of the cylindrical portion 21a.

The movable contact member 22 of the rotor 3 includes a circular shaped plate made of electrically-conductive metallic materials, and has a diameter which is accommodated within the cylindrical portion 21a of the rotor main body 21. At the center of the movable contact member 22, there is formed a central hole 29 through which the rotating shaft 27 of the rotor 3 is inserted. On the outer periphery of the movable contact member 22, three pairs of parallel slits 30 are formed at circumferentially equally-spaced apart positions. Between each of the pair of slits 30, elastic contact segments 31, 32, and 33 are provided.

The contact segment 31 of the movable contact member 22 projects from the innermost end of the slit 30 toward the rotor main body 21, then is bent 90° outward to form a contact portion 31a, and further bent 90° in the direction away from the rotor main body 21 to form an engage portion 31b. On a surface opposing to the rotor main body 21 of the contact portion 31a, the common movable contact 31c is formed. Similarly, the contact segment 32 has a contact portion 32a, an engage portion 32b, and the constantly-opened movable contact 32c. Likewise, the contact segment 33 has a contact portion 33a, an engage portion 33b, and the constantly-closed movable contact 33c. The contact portions 31a, 32a, and 33a are engaged in the holes 28 of the rotor main body 21. The engage portions 31b, 32b, and 33b are engaged in the engaging grooves 23 of the rotor main body 21.

The biasing spring 4 has a coiled shape as illustrated in FIG. 2, and is compressible toward the central axis and twistable about the central axis. The biasing spring 4 is inserted from the outside to the rotating shaft 27 of the rotor main body 21, and is configured such that one end thereof is locked to the locking groove 26 of the rotor main body 21 and another end thereof is locked to the locking portion 19 of the base 2.

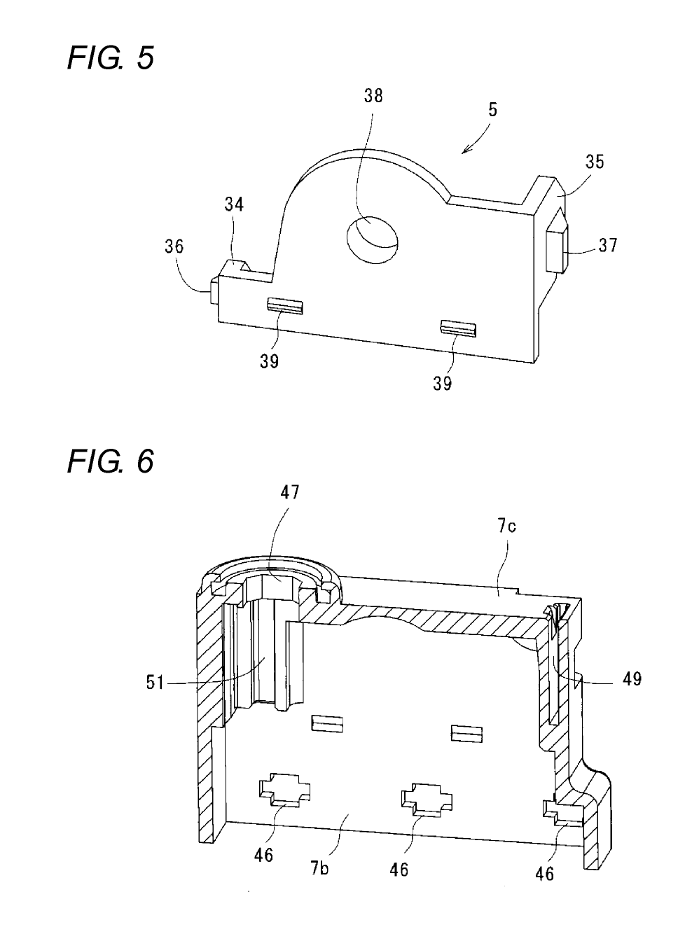

The holder 5 has a plate shape, and closes the opening on the front surface of the base 2 as illustrated in FIG. 2. As illustrated in FIG. 5, at both ends of the holder 5 in a left-right direction, there are formed a left ear 34 and a right ear 35 which project toward the base 2. The engaging projection 36 which is locked to the locking portion 12 of the base 2 is formed on an outer surface of the left ear 34, and the engaging projection 37 which is to be locked to the locking hole 20 of the base 2 is formed on the right ear 35. At a substantial center of the holder 5, there is formed a central hole 38 through which the rotating shaft 27 of the rotor 3 is inserted. On a surface opposite to the base 2 of the holder 5, there is formed a pair of engaging projections 39, each of which is engaged in an engaging hole 45 of the cover 7, to be described below.

The push button 6 has a prismatic shape as illustrated in FIG. 2. The push button 6 has a hemispherical operation unit 40 at the upper end thereof, and has a press part 41 for depressing the engaging projecting portion 24 of the rotor 3 at the lower end thereof. The press part 41, at both sides thereof, has a pair of opposing leg portions 42 sandwiching the engaging projecting portion 24 of the rotor 3. On an outer surface of each of the pair of leg portions 42, there is formed a guide projection 43 extending in an axial direction.

The cover 7 has a box shape whose bottom surface is open as illustrated in FIGS. 1A and 1B. On a front wall 7a of the cover 7, there are formed three bus bar inserting holes 44, and two engaging holes 45 which are engaged by the engaging projections 39 of the holder 5. Also on a back wall 7b of the cover 7, as illustrated in FIG. 6, there are formed three bus bar inserting holes 46 in positions opposing to the positions of the bus bar inserting holes 44 of the front wall 7a, and there are formed two engaging holes 46 which are engaged by not-illustrated engaging projections formed on the back portion 2b of the base 2. As illustrated in FIG. 1A, 1B, and 2, a top wall 7c of the cover 7 has, at the left side thereof, a generally rectangular shaped insertion hole 47 through which the push button 6 is inserted, a bleed hole 48 formed at the center thereof, and a slit opening 49 for inserting a not-illustrated lever used in lever-operating-type switches formed at the right side thereof. At the corner portion formed by the front wall 7a and the back wall 7b of the cover 7, there is formed a rotating shaft 50 of the not-illustrated lever for depressing the push button 6. On an inner surface of the cover 7, as illustrated in FIG. 6, below the insertion hole 47 through which the push button 6 is inserted, there are vertically formed guide grooves 51 in which the guide projections 43 of the push button 6 are slidably engaged.

As illustrated in FIG. 2, the cap 8 is attached to a rim of the insertion hole 47 such that the operation unit 40 at the upper end of the push button 6 projecting through the insertion hole 47 of the cover 7 is covered thereby.

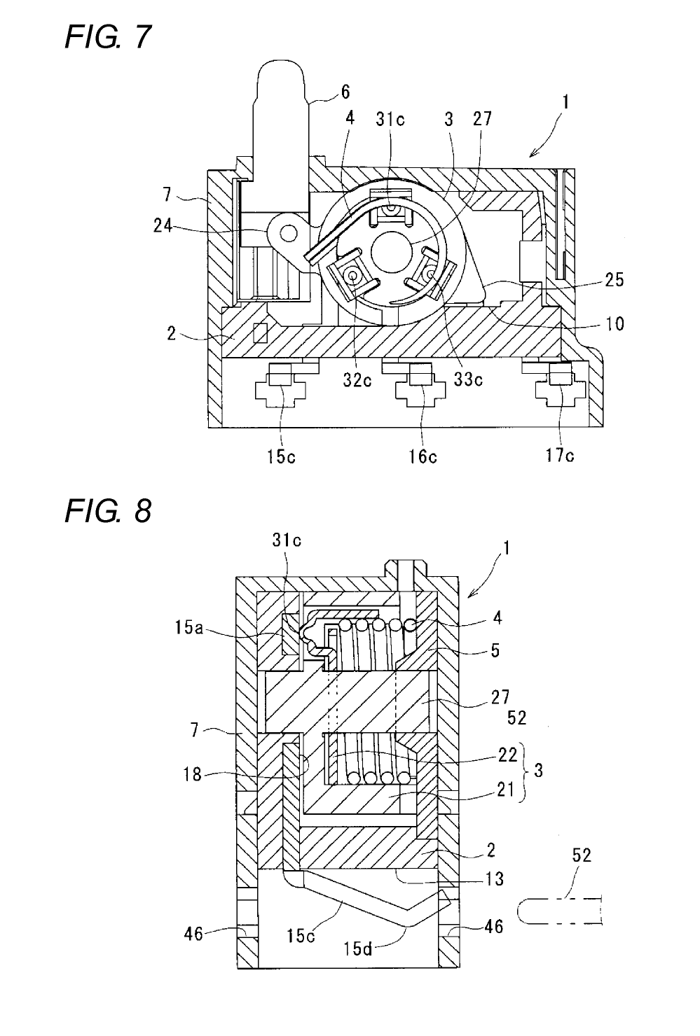

In order to assemble the push button switch 1 configured as described above, as illustrated in FIGS. 4A and 4B, the movable contact member 22 is first to be installed in the rotor main body 21 to obtain the rotor 3. At this point, the rotating shaft 27 of the rotor main body 21 is inserted to the central hole 29 of the movable contact member 22. Then, the engage portions 31b, 32b, and 33b of the movable contact member 22 are engaged in the engaging grooves 23 of the rotor main body 21. The movable contact member 22 is pushed into the rotor main body 21, so that the contact portions 31a, 32a, and 33a are engaged in the holes 28 of the rotor main body 21. This arrangement allows the common movable contact 31c, the constantly-opened movable contact 32c, and the constantly-closed movable contact 33c of the movable contact member 22 to be projected from the end wall 21b of the rotor main body 21. Next, as illustrated in FIG. 2, the rotating shaft 27 projecting outward from the end wall 21b of the rotor 3 is inserted into the shaft hole 14 of the back portion 2b of the base 2 so that the rotor 3 is accommodated in the rotor accommodating space 9. Subsequently, one end of the biasing spring 4 is locked to the locking groove 26 of the rotor 3, and another end is twistably locked to the locking portion 19 of the base 2. Accordingly, in FIG. 7, the rotor 3 is biased in a clockwise direction. The stopper 25 of the rotor 3 comes into contact with the rotor contact step 10 of the base 2, and the rotor 3 comes to rest in a biased manner in a clockwise direction.

Next, as illustrated in FIG. 2, the holder 5 is attached to the base 2 to cover the opening on the front surface of the base 2, so that the engaging projections 36 and 37 at the both ends thereof are locked respectively to the locking portion 19 and the locking hole 20 of the base 2. With this arrangement, the rotor 3 and the biasing spring 4 are covered with the holder 5. Also, as illustrated in FIG. 8, since the holder 5 depresses the biasing spring 4, the rotor 3 is biased in a direction of the rotating shaft 27 toward the contact disposition surface 18 of the base 2, thereby allowing the common movable contact 31c, the constantly-opened movable contact 32c, and the constantly-closed movable contact 33c of the movable contact member 22 to be pressed respectively against the common fixed contact 15a, the constantly-opened fixed contact 16a, and the constantly-closed fixed contact 17a of the contact disposition surface 18 of the base.

Meanwhile, the push button 6 is inserted from the inside into the insertion hole 46 of the cover 7 to engage the guide projection 43 with the guide groove 51. The cap 8 is installed in the rim of the insertion hole such that the operation unit 40 of the push button 6 projecting through the insertion hole 47 is covered thereby. The rotor 3 being assembled as described above is inserted into the cover 7 in the above state from the opening at the lower end of the base 2. The engaging projections 36 and 37 of the holder 5 and the not-illustrated engaging projections of the base 2 are engaged with the engaging hole 45 and the insertion hole 47 of the cover 7. In this state, the press part 41 at the lower end of the push button 6 is brought into a state of being engaged with the engaging projecting portion 24 of the rotor 3. Thus, the assembly of the push button switch 1 is completed.

In the push button switch 1 of the present embodiment thus assembled, as illustrated in FIG. 7, since the contacts 31c, 32c, and 33c are disposed within the diameter of the rotor 3, the push button switch 1 has a low profile. Also, by a push operation of the push button 6, the rotor 3 is rotatably moved to rotate the contacts 31c, 32c, and 33c, and there is thus no movement of the contact mechanism (contacts 31c, 32c, and 33c) in the movement direction of the push button 6. Therefore, it is not necessary to design a housing including the base 2 and the cover 7 in consideration of the distance of movement of the contact mechanism, and the switch, as a whole, has a so-called low profile. Also, since the push button 6 is adjoined to the outer peripheral surface of the rotor 3, and movably disposed in a direction orthogonal to the rotating shaft 27 of the rotor 3, the height of the push button switch 1 is not influenced. Further, since the linear movement of the push button 6 is converted into rotation of the rotor 3, the stroke of the push button 6 can be made larger.

Also, as illustrated in FIG. 8, since the terminal portions 15c, 16c, and 17c of the push button switch 1 are projected from the terminal disposition surface 13 of the base 2 at an angle, the height of the push button switch 1 is less influenced by the projection dimension of the terminal portions 15c, 16c, and 17c.

Further, the push button switch 1 is electrically connectable with the bent portions 15d, 16d, and 17d by inserting bus bars into the bus bar inserting holes 44 and 46 formed on the opposing walls of the cover 7 that are orthogonal to the terminal disposition surface 13. Accordingly, the connection to the terminal portions 15c, 16c, and 17c of the push button switch 1 can be established from a lateral side of the push button switch 1, thereby thinning the electronic device on which the push button switch 1 is mounted.

Next, operation of the push button switch 1 having the configuration as described above will be described.

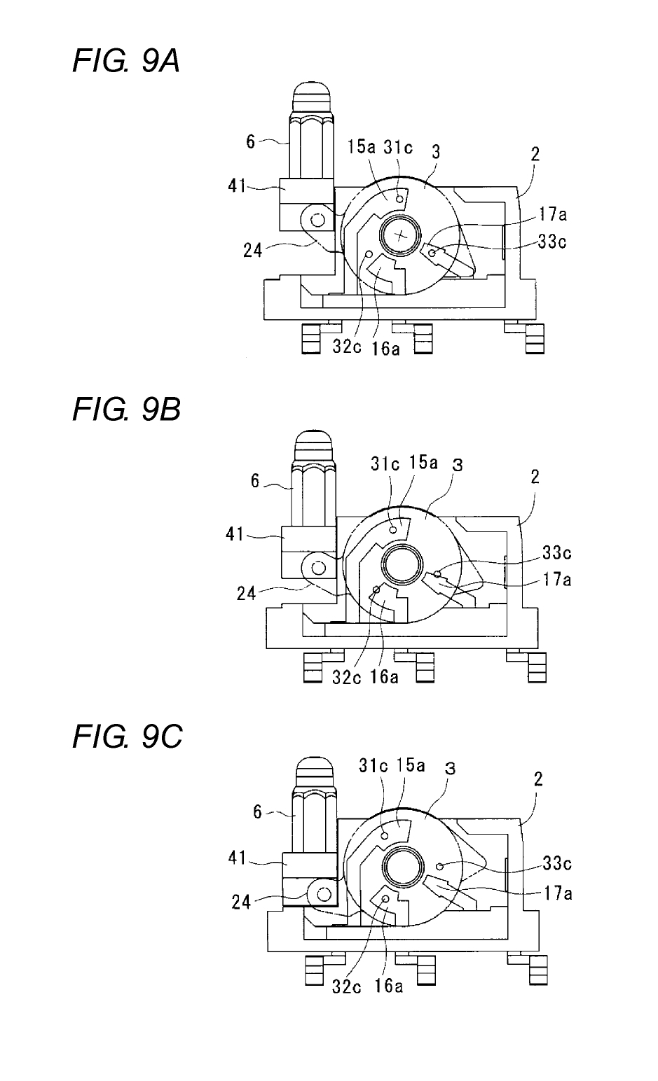

In a state where the push button 6 is not pressed, as illustrated in FIG. 9A, the common movable contact 31c, the constantly-opened movable contact 32c, and the constantly-closed movable contact 33c of the rotor 3 are respectively in the positions at 0°, 120°, and 240° counterclockwise when viewing the front surface of the base 2. Accordingly, the common movable contact 31c of the rotor 3 is closed to the common fixed contact 15a of the base 2, the constantly-opened movable contact 32c of the rotor 3 is opened and separated from the constantly-opened fixed contact 16a of the base 2, and the constantly-closed movable contact 33c of the rotor 3 is closed to the constantly-closed fixed contact 17a of the base 2 to be in an OFF state.

From this state, when the push button 6 is pressed down, as illustrated in FIG. 9B, the press part 41 of the push button 6 depresses the engaging projecting portion 24 of the rotor 3. Accordingly, the linear movement of the push button 6 is converted into rotation of the rotor 3, and the rotor 3 is rotated about the rotating shaft 27 in the counterclockwise direction in FIG. 9B against the biasing force of the biasing spring 4. As a result, as illustrated in FIG. 9B, while the common movable contact 31c of the rotor 3 is maintained closed to the common fixed contact 15a of the base 2, the constantly-opened movable contact 32c of the rotor 3 is closed to the constantly-opened fixed contact 16a of the base 2, and the constantly-closed movable contact 33c of the rotor 3 is opened and separated from the constantly-closed fixed contact 17c of the base 2 to be brought into an ON state. The ON state is retained by a not-illustrated retaining mechanism.

From the ON state, when the push button 6 is pushed, the not-illustrated retaining mechanism is released. Then, as illustrated in FIG. 9C, the rotor 3 is rotated in the clockwise direction in FIG. 9C with the biasing force of the biasing spring 4 so as to perform operations reverse to the aforementioned operations, and is brought into an OFF state.

As described above, while the OFF state is switched to the ON state, the constantly-opened movable contact 32c of the rotor 3 is closed to the constantly-opened fixed contact 16a of the base 2, and there exists a state where the constantly-closed movable contact 33c of the rotor 3 is closed to the constantly-closed fixed contact 17a of the base 2. That is, the constantly-opened movable contact 32c of the rotor 3 comes into contact with the constantly-opened fixed contact 16a of the base 2 before the constantly-closed movable contact 33c of the rotor 3 separates from the constantly-closed fixed contact 17a of the base 2. As described above, in the push button switch 1, a Make Before Break (MBB) contact can be established.

The present embodiment can be modified in various ways. In place of depressing the engaging projecting portion disposed on the outer periphery of the rotor by the push button, a recess may be disposed on the outer periphery of the rotor, or a projection may be disposed on the end surface of the rotor so that the press part of the push button is engaged to the recess or the projection.

Also, the movable contacts of the rotor can be formed in the rotor main body by means of insert molding.

In accordance with the arrangements described above, when the push button is pressed, linear movement of the push button is converted into rotation of the rotor, so that the movable contact of the rotor comes into contact with and separate from the fixed contact of the base to switch contacts. In the arrangements described above, contact mechanism can be disposed within the diameter of the rotor. Since the contact mechanism does not move in a direction of movement of the push button, the push button switch can be made low profile. Also, since the push button is positioned to adjoin to the outer peripheral surface of the rotor, the height of the push button switch is not influenced. Further, since the linear movement of the push button is converted into rotation of the rotor, the stroke of the push button can be made larger.

According to the embodiments of the invention, a contact mechanism can be disposed within the diameter of the rotor. Since the contact mechanism does not move in a direction of movement of the push button, the push button switch can be made low profile. Also, since the push button is positioned to adjoin to the outer peripheral surface of the rotor, the height of the push button switch is not influenced. Further, since the linear movement of the push button is converted into rotation of the rotor, there is an advantage that the stroke of the push button can be made larger.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A push button switch comprising:
a base comprising a contact disposition surface on which a plurality of fixed contacts are positioned around a circle;
a rotor rotatably disposed on the base about a rotating shaft passing through a center of the circle, the rotor comprising a plurality of movable contacts positioned to come into contact with and separate from the plurality of fixed contacts about the rotating shaft;
a push button adjoined to an outer peripheral surface of the rotor and movably disposed in a direction orthogonal to the rotating shaft of the rotor, the push button being configured to rotate the rotor by a push operation; and
a cover configured to accommodate the base, the rotor, and the push button, the cover exposing an operation unit of the push button.

2. The push button switch according to claim 1 comprising an engaging projecting portion with which a press part of the push button is engaged, the engaging projection portion being disposed on the outer peripheral surface of the rotor.

3. The push button switch according to claim 1 wherein the base comprises a terminal disposition surface from which a plurality of terminals to be connected to the plurality of fixed contacts project, the terminal disposition surface being orthogonal to the contact disposition surface of the base, and
the plurality of terminals project from the terminal disposition surface at an angle.

4. The push button switch according to claim 3 wherein the plurality of terminals, at each tip end, each comprises a bent portion extending toward the terminal disposition surface, bus bar inserting holes are formed on each of opposing walls of the cover that are orthogonal to the terminal disposition surface, and bus bars to be inserted into the bus bar inserting holes are in contact with the bent portions of the plurality of terminals.

5. The push button switch according to claim 1, wherein:
the plurality of fixed contacts of the base each comprise a common fixed contact, a constantly-closed fixed contact, and a constantly-opened fixed contact,
the plurality of movable contacts of the rotor each comprise a common movable contact connected with the common fixed contact of the base, a constantly-closed movable contact configured to come into contact with and separate from the constantly-closed fixed contact of the base and a constantly-opened movable contact configured come into contact with and separate from the constantly-opened fixed contact of the base, and
each of the fixed contacts and the movable contacts is positioned so that when the rotor is rotated by a push operation of the push button, the constantly-opened movable contact comes into contact with the constantly-opened fixed contact before the constantly-closed movable contact separates from the constantly-closed fixed contact.

6. The push button switch according to claim 2 wherein the base comprises a terminal disposition surface from which a plurality of terminals to be connected to the plurality of fixed contacts project, the terminal disposition surface being orthogonal to the contact disposition surface of the base, and
the plurality of terminals project from the terminal disposition surface at an angle.

7. The push button switch according to claim 6 wherein the plurality of terminals, at each tip end, each comprises a bent portion extending toward the terminal disposition surface, bus bar inserting holes are formed on each of opposing walls of the cover that are orthogonal to the terminal disposition surface, and bus bars inserted into the bus bar inserting holes are in contact with the bent portions of the plurality of terminals.

8. The push button switch according to claim 2, wherein:
the plurality of fixed contacts of the base each comprise a common fixed contact, a constantly-closed fixed contact, and a constantly-opened fixed contact,
the plurality of movable contacts of the rotor each comprise a common movable contact connected with the common fixed contact of the base, a constantly-closed movable contact configured to come into contact with and separate from the constantly-closed fixed contact of the base and a constantly-opened movable contact configured come into contact with and separate from the constantly-opened fixed contact of the base, and
each of the fixed contacts and the movable contacts is positioned so that when the rotor is rotated by a push operation of the push button, the constantly-opened movable contact comes into contact with the constantly-opened fixed contact before the constantly-closed movable contact separates from the constantly-closed fixed contact.

9. The push button switch according to claim 3, wherein:
the plurality of fixed contacts of the base each comprise a common fixed contact, a constantly-closed fixed contact, and a constantly-opened fixed contact,
the plurality of movable contacts of the rotor each comprise a common movable contact connected with the common fixed contact of the base, a constantly-closed movable contact configured to come into contact with and separate from the constantly-closed fixed contact of the base and a constantly-opened movable contact configured come into contact with and separate from the constantly-opened fixed contact of the base, and
each of the fixed contacts and the movable contacts is positioned so that when the rotor is rotated by a push operation of the push button, the constantly-opened movable contact comes into contact with the constantly-opened fixed contact before the constantly-closed movable contact separates from the constantly-closed fixed contact.

10. The push button switch according to claim 4, wherein:
the plurality of fixed contacts of the base each comprise a common fixed contact, a constantly-closed fixed contact, and a constantly-opened fixed contact,
the plurality of movable contacts of the rotor each comprise a common movable contact connected with the common fixed contact of the base, a constantly-closed movable contact configured to come into contact with and separate from the constantly-closed fixed contact of the base and a constantly-opened movable contact configured come into contact with and separate from the constantly-opened fixed contact of the base, and
each of the fixed contacts and the movable contacts is positioned so that when the rotor is rotated by a push operation of the push button, the constantly-opened movable contact comes into contact with the constantly-opened fixed contact before the constantly-closed movable contact separates from the constantly-closed fixed contact.

11. The push button switch according to claim 6, wherein:
the plurality of fixed contacts of the base each comprise a common fixed contact, a constantly-closed fixed contact, and a constantly-opened fixed contact,
the plurality of movable contacts of the rotor each comprise a common movable contact connected with the common fixed contact of the base, a constantly-closed movable contact configured to come into contact with and separate from the constantly-closed fixed contact of the base and a constantly-opened movable contact configured come into contact with and separate from the constantly-opened fixed contact of the base, and
each of the fixed contacts and the movable contacts is positioned so that when the rotor is rotated by a push operation of the push button, the constantly-opened movable contact comes into contact with the constantly-opened fixed contact before the constantly-closed movable contact separates from the constantly-closed fixed contact.

12. The push button switch according to claim 7, wherein:
the plurality of fixed contacts of the base each comprise a common fixed contact, a constantly-closed fixed contact, and a constantly-opened fixed contact,
the plurality of movable contacts of the rotor each comprise a common movable contact connected with the common fixed contact of the base, a constantly-closed movable contact configured to come into contact with and separate from the constantly-closed fixed contact of the base and a constantly-opened movable contact configured come into contact with and separate from the constantly-opened fixed contact of the base, and
each of the fixed contacts and the movable contacts is positioned so that when the rotor is rotated by a push operation of the push button, the constantly-opened movable contact comes into contact with the constantly-opened fixed contact before the constantly-closed movable contact separates from the constantly-closed fixed contact.
